(19) United States
(12) Patent Application Publication
(10) Pub. No.: US 2025/0150491 A1
(43) Pub. Date: May 8, 2025

(54) TETHERED DEVICES FOR WEBRTC IN A CELLULAR SYSTEM

(71) Applicant: QUALCOMM Incorporated, San Diego, CA (US)

(72) Inventors: Liangping Ma, San Diego, CA (US); Imed Bouazizi, Celina, TX (US); Nikolai Konrad Leung, San Francisco, CA (US)

(21) Appl. No.: 18/938,067

(22) Filed: Nov. 5, 2024

Related U.S. Application Data
(60) Provisional application No. 63/596,530, filed on Nov. 6, 2023.

(51) Int. Cl. H04L 65/1069; H04L 65/1104; H04L 65/1108; H04W 76/10

(52) U.S. Cl. CPC H04L 65/1069; H04L 65/1108; H04W 76/10; H04L 65/1104

(57) ABSTRACT

A tethering user equipment (UE) device, such as a cell phone, may be tethered to a tethered device, such as augmented reality (AR) glasses. The tethered device may execute a Web Real-time Communication Protocol (WebRTC) endpoint application, and the tethering UE device may execute a WebRTC endpoint support function. The tethering UE device may access WebRTC signaling functions of a WebRTC operator network on behalf of the tethered device to send and receive AR media data of a WebRTC communication session. The tethered device may present received AR media data (e.g., audio, video, and image data) and may collect and send user movement data (e.g., view orientation, physical movement data, controller interaction data, or the like) to the tethering UE device to cause the tethering UE device to send the user movement data to other devices participating in the WebRTC communication session.

This application claims the benefit of U.S. Provisional Application No. 63/596,530, filed Nov. 6, 2023, the entire contents of which are hereby incorporated by reference.

### TECHNICAL FIELD

This disclosure relates to transport of media data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into macroblocks. Each macroblock can be further partitioned. Macroblocks in an intra-coded (I) frame or slice are encoded using spatial prediction with respect to neighboring macroblocks. Macroblocks in an inter-coded (P or B) frame or slice may use spatial prediction with respect to neighboring macroblocks in the same frame or slice or temporal prediction with respect to other reference frames.

After video data has been encoded, the video data may be packetized for transmission or storage. The video data may be assembled into a video file conforming to any of a variety of standards, such as the International Organization for Standardization (ISO) base media file format and extensions thereof, such as AVC.

### SUMMARY

In general, this disclosure describes techniques for exchanging media data. In particular, this disclosure describes techniques by which a user equipment (UE) device may be tethered to a tethered UE device, and where the UE device and the tethered UE device may jointly participate in a communication session, such as a WebRTC communication session.

In one example, a method of exchanging media data includes: executing, by a tethering user equipment (UE) device, a Web Real-time Communication Protocol (WebRTC) Endpoint Support Function to access WebRTC signaling functions of a WebRTC operator network and to receive media data of a WebRTC communication session from the WebRTC operator network, wherein the tethering UE device is tethered to a tethered device that executes a WebRTC Endpoint Application; and sending, by the tethering UE device, the received media data of the WebRTC communication session to the tethered device to cause the tethered device to present the media data.

In another example, a tethering user equipment (UE) device for participating in a Web Real-time Communication Protocol (WebRTC) communication session includes: a memory configured to store media data; a communication interface communicatively coupled to a tethered device that executes a WebRTC Endpoint Application; and a processing system implemented in circuitry and configured to: execute a WebRTC Endpoint Support Function to access WebRTC signaling functions of a WebRTC operator network and to receive media data of a WebRTC communication session from the WebRTC operator network; and send the received media data of the WebRTC communication session to the tethered device to cause the tethered device to present the media data.

In another example, a method of exchanging media data includes: executing, by a tethered device, a Web Real-time Communication Protocol (WebRTC) Endpoint Application to participate in a WebRTC communication session, wherein the tethered device is tethered to a tethering UE device that executes a WebRTC Endpoint Support Function; receiving, by the tethered device, media data of the WebRTC communication session from the tethering UE device; and presenting, by the tethered device, the media data of the WebRTC communication session.

In another example, a tethered device for exchanging media data includes: a memory configured to store media data; at least one display; a communication interface communicatively coupled to a tethering user equipment (UE) device that executes a Web Real-time Communication Protocol (WebRTC) Endpoint Support Function; and a processing system implemented in circuitry and configured to: execute a WebRTC Endpoint Application to participate in a WebRTC communication session; receive media data of the WebRTC communication session from the tethering UE device; and present the media data of the WebRTC communication session via the at least one display.

In another example, a system for exchanging media data of a Web Real-time Communication Protocol (WebRTC) communication session includes: a tethered device for participating in the WebRTC communication session; and a tethering user equipment (UE) device for participating in the WebRTC communication session, the tethering UE device comprising: a memory configured to store media data; a communication interface communicatively coupled to the tethered device; and a processing system implemented in circuitry and configured to: execute a WebRTC Endpoint Support Function to access WebRTC signaling functions of a WebRTC operator network and to receive media data of the WebRTC communication session from the WebRTC operator network; and send the received media data of the WebRTC communication session to the tethered device to cause the tethered device to present the media data, wherein the tethered device comprises: a memory configured to store media data; at least one display; a communication interface communicatively coupled to the tethering user UE; and a processing system implemented in circuitry and configured to: execute a WebRTC Endpoint Application to participate in the WebRTC communication session; receive media data of the WebRTC communication session from the tethering UE device; and present the media data of the WebRTC communication session via the at least one display.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for streaming media data over a network.

FIG. 2 is a block diagram illustrating elements of an example video file.

FIG. 3 is a block diagram illustrating an example RTP Control Protocol (RCP) architecture that may support Web Real-time Communication Protocol (WebRTC) in a 3GPP-based system.

FIG. 4 is a block diagram illustrating an example enhanced immersive Real-time Communication for WebRTC (ieRTCW) architecture including an operator network including a WebRTC Domain, with which a UE including a WebRTC Endpoint communicates.

FIG. 5 is a conceptual diagram illustrating an example set of components that may be involved in a WebRTC session for which a UE is tethered to another device.

FIGS. 6-8 are block diagrams illustrating example architectures in which the techniques of this disclosure may be performed.

FIG. 9 is a flow diagram illustrating an example WebRTC setup procedure for the iRTCW architecture according to techniques of this disclosure.

FIGS. 10-12 are block diagrams illustrating additional example architectures in which the techniques of this disclosure may be performed.

FIG. 13 is a flowchart illustrating an example method that may be performed by a tethering user equipment (UE) device, such as a cell phone, and a tethered device, such as augmented reality (AR) glasses.

### DETAILED DESCRIPTION

This disclosure describes techniques by which a tethering user equipment (UE) device, such as a cellular phone, and a tethered device, such as augmented reality (AR) glasses, can operate together to exchange and use AR data during an AR communication session. For example, the tethering UE device may be configured to interact with radio access network (RAN) components, such as a Web Real-time Communication (WebRTC) operator network. The tethering device may send and receive WebRTC data as part of the AR communication session, and send media data of the AR communication session to the AR glasses for display. In this manner, the AR glasses need not include components configured to perform all client actions of the WebRTC communication session, but still participate in the communication session.

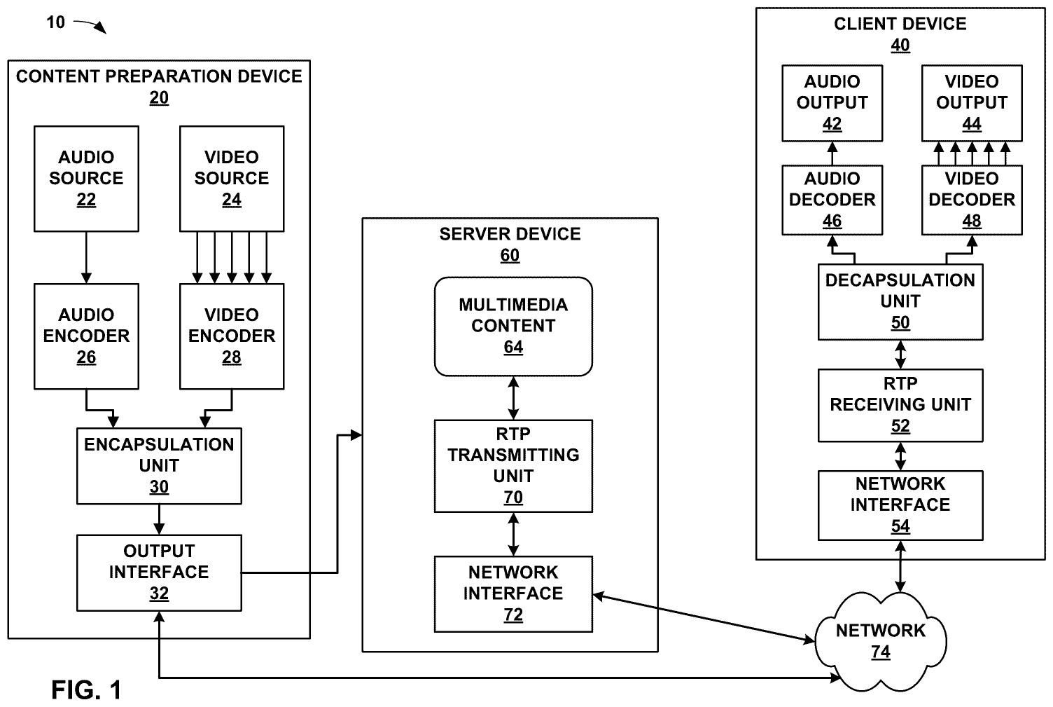

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network, or may be directly communicatively coupled. In some examples, content preparation device 20 and server device 60 may comprise the same device.

Content preparation device 20, in the example of FIG. 1, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for an encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a media presentation. For example, the coded video or audio part of the media presentation can be an elementary stream. An elementary stream may be converted into a packetized elementary stream (PES) before being encapsulated within a video file. Within the same media presentation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into streamable media data.

Encapsulation unit 30 receives PES packets for elementary streams of a media presentation from audio encoder 26 and video encoder 28 and forms corresponding network abstraction layer (NAL) units from the PES packets. Coded video segments may be organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and SEI NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not to be repeated for each sequence or picture; hence, coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of SVC and view scalability information SEI messages in MVC. These example SEI messages may convey information on, e.g., extraction of operation points and characteristics of the operation points.

Server device 60 includes Real-time Transport Protocol (RTP) transmitting unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64 and include components that conform substantially to those of server device 60. In general, network interface 72 is configured to send and receive data via network 74.

RTP transmitting unit 70 is configured to deliver media data to client device 40 via network 74 according to RTP, which is standardized in Request for Comment (RFC) 3550 by the Internet Engineering Task Force (IETF). RTP transmitting unit 70 may also implement protocols related to RTP, such as RTP Control Protocol (RTCP), Real-time Streaming Protocol (RTSP), Session Initiation Protocol (SIP), and/or Session Description Protocol (SDP). RTP transmitting unit 70 may send media data via network interface 72, which may implement Uniform Datagram Protocol (UDP) and/or Internet protocol (IP). Thus, in some examples, server device 60 may send media data via RTP and RTSP over UDP using network 74.

RTP transmitting unit 70 may receive an RTSP describe request from, e.g., client device 40. The RTSP describe request may include data indicating what types of data are supported by client device 40. RTP transmitting unit 70 may respond to client device 40 with data indicating media streams, such as media content 64, that can be sent to client device 40, along with a corresponding network location identifier, such as a uniform resource locator (URL) or uniform resource name (URN).

RTP transmitting unit 70 may then receive an RTSP setup request from client device 40. The RTSP setup request may generally indicate how a media stream is to be transported. The RTSP setup request may contain the network location identifier for the requested media data (e.g., media content 64) and a transport specifier, such as local ports for receiving RTP data and control data (e.g., RTCP data) on client device 40. RTP transmitting unit 70 may reply to the RTSP setup request with a confirmation and data representing ports of server device 60 by which the RTP data and control data will be sent. RTP transmitting unit 70 may then receive an RTSP play request, to cause the media stream to be “played,” i.e., sent to client device 40 via network 74. RTP transmitting unit 70 may also receive an RTSP teardown request to end the streaming session, in response to which, RTP transmitting unit 70 may stop sending media data to client device 40 for the corresponding session.

RTP receiving unit 52, likewise, may initiate a media stream by initially sending an RTSP describe request to server device 60. The RTSP describe request may indicate types of data supported by client device 40. RTP receiving unit 52 may then receive a reply from server device 60 specifying available media streams, such as media content 64, that can be sent to client device 40, along with a corresponding network location identifier, such as a uniform resource locator (URL) or uniform resource name (URN).

RTP receiving unit 52 may then generate an RTSP setup request and send the RTSP setup request to server device 60. As noted above, the RTSP setup request may contain the network location identifier for the requested media data (e.g., media content 64) and a transport specifier, such as local ports for receiving RTP data and control data (e.g., RTCP data) on client device 40. In response, RTP receiving unit 52 may receive a confirmation from server device 60, including ports of server device 60 that server device 60 will use to send media data and control data.

After establishing a media streaming session between server device 60 and client device 40, RTP transmitting unit 70 of server device 60 may send media data (e.g., packets of media data) to client device 40 according to the media streaming session. Server device 60 and client device 40 may exchange control data (e.g., RTCP data) indicating, for example, reception statistics by client device 40, such that server device 60 can perform congestion control or otherwise diagnose and address transmission faults.

Network interface 54 may receive and provide media of a selected media presentation to RTP receiving unit 52, which may in turn provide the media data to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, RTP receiving unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, RTP receiving unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well as audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via RTP receiving unit 52. Decapsulation unit 50 may decapsulate a elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

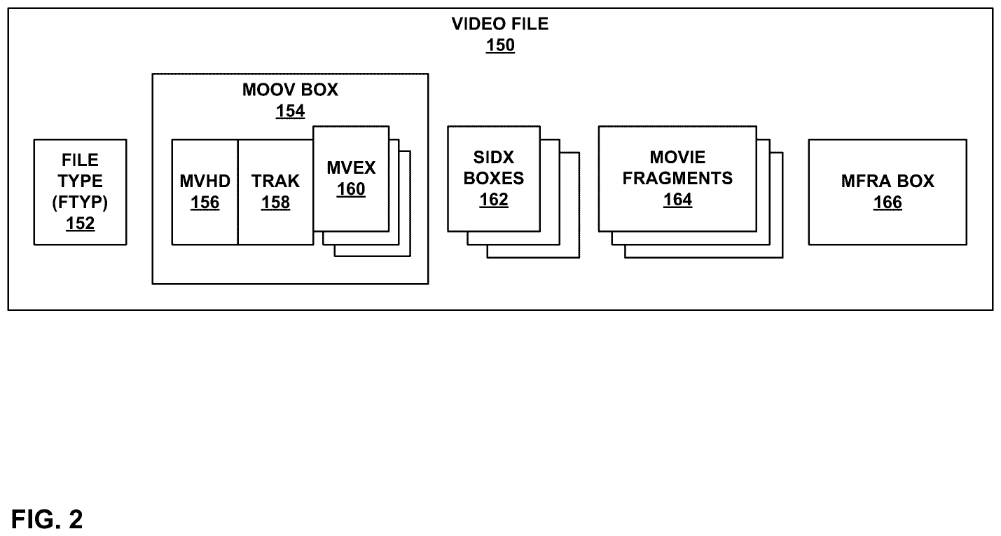

FIG. 2 is a block diagram illustrating elements of an example video file 150. As described above, video files in accordance with the ISO base media file format and extensions thereof store data in a series of objects, referred to as “boxes.” In the example of FIG. 2, video file 150 includes file type (FTYP) box 152, movie (MOOV) box 154, segment index (sidx) boxes 162, movie fragment (MOOF) boxes 164, and movie fragment random access (MFRA) box 166. Although FIG. 2 represents an example of a video file, it should be understood that other media files may include other types of media data (e.g., audio data, timed text data, or the like) that is structured similarly to the data of video file 150, in accordance with the ISO base media file format and its extensions.

File type (FTYP) box 152 generally describes a file type for video file 150. File type box 152 may include data that identifies a specification that describes a best use for video file 150. File type box 152 may alternatively be placed before MOOV box 154, movie fragment boxes 164, and/or MFRA box 166.

MOOV box 154, in the example of FIG. 2, includes movie header (MVHD) box 156, track (TRAK) box 158, and one or more movie extends (MVEX) boxes 160. In general, MVHD box 156 may describe general characteristics of video file 150. For example, MVHD box 156 may include data that describes when video file 150 was originally created, when video file 150 was last modified, a timescale for video file 150, a duration of playback for video file 150, or other data that generally describes video file 150.

TRAK box 158 may include data for a track of video file 150. TRAK box 158 may include a track header (TKHD) box that describes characteristics of the track corresponding to TRAK box 158. In some examples, TRAK box 158 may include coded video pictures, while in other examples, the coded video pictures of the track may be included in movie fragments 164, which may be referenced by data of TRAK box 158 and/or sidx boxes 162.

In some examples, video file 150 may include more than one track. Accordingly, MOOV box 154 may include a number of TRAK boxes equal to the number of tracks in video file 150. TRAK box 158 may describe characteristics of a corresponding track of video file 150. For example, TRAK box 158 may describe temporal and/or spatial information for the corresponding track. A TRAK box similar to TRAK box 158 of MOOV box 154 may describe characteristics of a parameter set track, when encapsulation unit 30 (FIG. 1) includes a parameter set track in a video file, such as video file 150. Encapsulation unit 30 may signal the presence of sequence level SEI messages in the parameter set track within the TRAK box describing the parameter set track.

MVEX boxes 160 may describe characteristics of corresponding movie fragments 164, e.g., to signal that video file 150 includes movie fragments 164, in addition to video data included within MOOV box 154, if any. In the context of streaming video data, coded video pictures may be included in movie fragments 164 rather than in MOOV box 154. Accordingly, all coded video samples may be included in movie fragments 164, rather than in MOOV box 154.

MOOV box 154 may include a number of MVEX boxes 160 equal to the number of movie fragments 164 in video file 150. Each of MVEX boxes 160 may describe characteristics of a corresponding one of movie fragments 164. For example, each MVEX box may include a movie extends header box (MEHD) box that describes a temporal duration for the corresponding one of movie fragments 164.

As noted above, encapsulation unit 30 may store a sequence data set in a video sample that does not include actual coded video data. A video sample may generally correspond to an access unit, which is a representation of a coded picture at a specific time instance. In the context of AVC, the coded picture may include one or more VCL NAL units, which contain the information to construct all the pixels of the access unit and other associated non-VCL NAL units, such as SEI messages. Accordingly, encapsulation unit 30 may include a sequence data set, which may include sequence level SEI messages, in one of movie fragments 164. Encapsulation unit 30 may further signal the presence of a sequence data set and/or sequence level SEI messages as being present in one of movie fragments 164 within the one of MVEX boxes 160 corresponding to the one of movie fragments 164.

SIDX boxes 162 are optional elements of video file 150. That is, video files conforming to the 3GPP file format, or other such file formats, do not necessarily include SIDX boxes 162. In accordance with the example of the 3GPP file format, a SIDX box may be used to identify a sub-segment of a segment (e.g., a segment contained within video file 150). The 3GPP file format defines a sub-segment as “a self-contained set of one or more consecutive movie fragment boxes with corresponding Media Data box(es) and a Media Data Box containing data referenced by a Movie Fragment Box must follow that Movie Fragment box and precede the next Movie Fragment box containing information about the same track.” The 3GPP file format also indicates that a SIDX box “contains a sequence of references to subsegments of the (sub)segment documented by the box. The referenced subsegments are contiguous in presentation time. Similarly, the bytes referred to by a Segment Index box are always contiguous within the segment. The referenced size gives the count of the number of bytes in the material referenced.”

SIDX boxes 162 generally provide information representative of one or more sub-segments of a segment included in video file 150. For instance, such information may include playback times at which sub-segments begin and/or end, byte offsets for the sub-segments, whether the sub-segments include (e.g., start with) a stream access point (SAP), a type for the SAP (e.g., whether the SAP is an instantaneous decoder refresh (IDR) picture, a clean random access (CRA) picture, a broken link access (BLA) picture, or the like), a position of the SAP (in terms of playback time and/or byte offset) in the sub-segment, and the like.

Movie fragments 164 may include one or more coded video pictures. In some examples, movie fragments 164 may include one or more groups of pictures (GOPs), each of which may include a number of coded video pictures, e.g., frames or pictures. In addition, as described above, movie fragments 164 may include sequence data sets in some examples. Each of movie fragments 164 may include a movie fragment header box (MFHD, not shown in FIG. 2). The MFHD box may describe characteristics of the corresponding movie fragment, such as a sequence number for the movie fragment. Movie fragments 164 may be included in order of sequence number in video file 150.

MFRA box 166 may describe random access points within movie fragments 164 of video file 150. This may assist with performing trick modes, such as performing seeks to particular temporal locations (i.e., playback times) within a segment encapsulated by video file 150. MFRA box 166 is generally optional and need not be included in video files, in some examples. Likewise, a client device, such as client device 40, does not necessarily need to reference MFRA box 166 to correctly decode and display video data of video file 150. MFRA box 166 may include a number of track fragment random access (TFRA) boxes (not shown) equal to the number of tracks of video file 150, or in some examples, equal to the number of media tracks (e.g., non-hint tracks) of video file 150.

In some examples, movie fragments 164 may include one or more stream access points (SAPs), such as IDR pictures. Likewise, MFRA box 166 may provide indications of locations within video file 150 of the SAPs. Accordingly, a temporal sub-sequence of video file 150 may be formed from SAPs of video file 150. The temporal sub-sequence may also include other pictures, such as P-frames and/or B-frames that depend from SAPs. Frames and/or slices of the temporal sub-sequence may be arranged within the segments such that frames/slices of the temporal sub-sequence that depend on other frames/slices of the sub-sequence can be properly decoded. For example, in the hierarchical arrangement of data, data used for prediction for other data may also be included in the temporal sub-sequence.

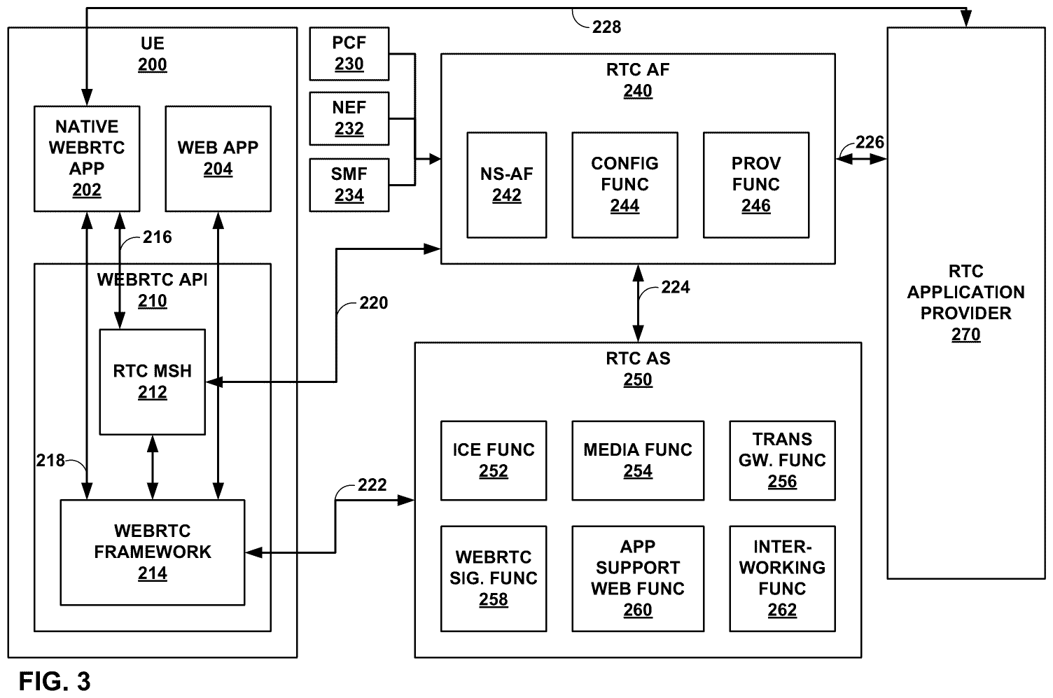

FIG. 3 is a block diagram illustrating an example RTP Control Protocol (RCP) architecture that may support Web Real-time Communication Protocol (WebRTC) in a 3GPP-based system. This example RCP architecture may correspond to 3GPP TS 26.506. In this example, the RCP architecture includes user equipment (UE) device 200, RTC application functions (AF) 240, RTC application server (AS) 250, and RTC application provider (AP) 270.

RTC AFs 240 includes network support function (NS-AF) 242, configuration function 244, and provisioning function 246. RTC AS 250 includes Interactive Connectivity Establishment (ICE) function 252, media function 254, transport gateway function 256, WebRTC signaling function 258, application supporting web function 260, and inter-working function 262. RTC AF 240 is also coupled to policy and charging function 230, network exposure function 232, and session management function 234. RTC AF 240 and RTC AS 250 are communicatively coupled by RTC-3 interface 224. RTC AF 240 and RTC application provider 270 are communicatively coupled by RTC-1 interface 226.

UE 200 includes an RTC Endpoint, which includes WebRTC APIs 210 including RTC Media Session Handler (MSH) 212 and WebRTC Framework 214. UE 200 also includes native WebRTC application 202 and web application 204. Native WebRTC application 202 and RTC MSH 212 are communicatively coupled by RTC-6 interface 216. Native WebRTC application 202 and WebRTC framework 214 are communicatively coupled by RTC-7 interface 218. RTC MSH 212 and RTC AF are communicatively coupled by RTC-5 interface 220. WebRTC framework 214 and RTC AS 250 are communicatively coupled by RTC-4 interface 222. Native WebRTC application 202 and RTC application provider 270 are communicatively coupled by RTC-8 interface 228.

This disclosure recognizes that conventional techniques do not define RTC functionality splitting and signaling needed for proper functioning when another device (such as XR/AR/VR/MR glasses) are tethered to the UE.

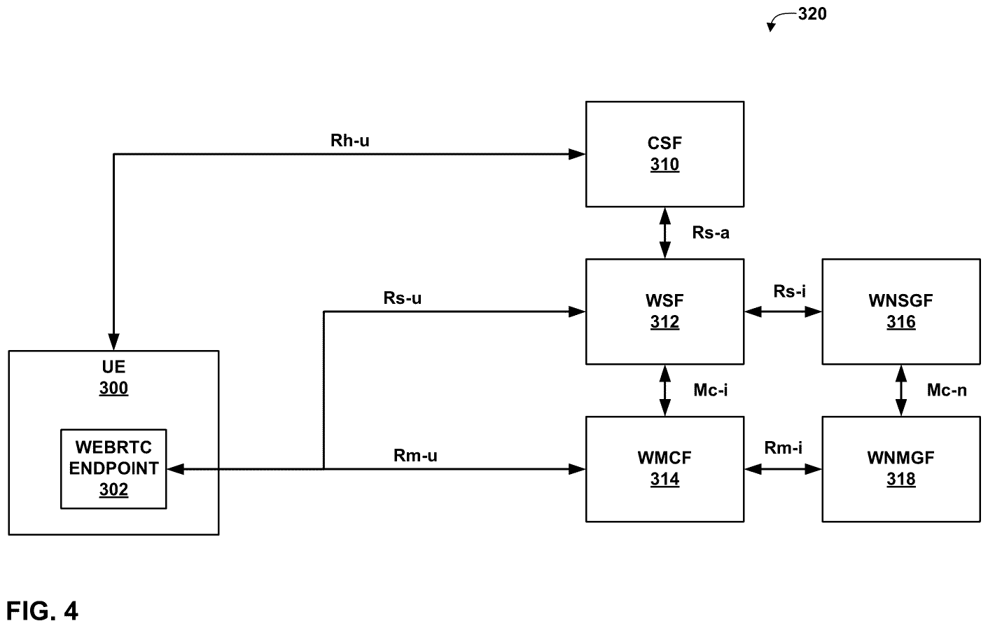

FIG. 4 is a block diagram illustrating an example enhanced immersive Real-time Communication for WebRTC (ieRTCW) architecture including operator network 320 including a WebRTC Domain, with which UE device 300 including WebRTC Endpoint 302 communicates. WebRTC Endpoint 302 may include both a native WebRTC application and a Web application, as shown in FIG. 3. WebRTC Endpoint 302 of FIG. 4 may correspond to the RTC Endpoint of FIG. 3.

In this example, Rh-u represents a reference point between conference session function (CSF) 310 and UE 300. CSF 310 may provide functionalities such as conference session management and application usage assistance, such as downloading an application to UE 300.

In this example, Rs-u represents a reference point between WebRTC signaling function (WSF) 312 and the UE. WSF 312 may handle offer/answer exchanges and may have access to Session Description Protocol (SDP) messages in both directions. WSF 312 is also communicatively coupled to WebRTC NNI signaling gateway function (WNSGF) 316 by an Rs-i interface.

In this example, Rm-u represents a reference point between WebRTC media center function (WMCF) 314 and UE 300. WMCF 314 may provide functionality including providing content to WebRTC Endpoint 302, mixing, serving as a multi-point control unit (MCU), selective forwarding unit (SFU), relay, or the like. WMCF 314 is communicatively coupled to WebRTC NNI media gateway function (WNMGF) 318 by an Rm-i interface.

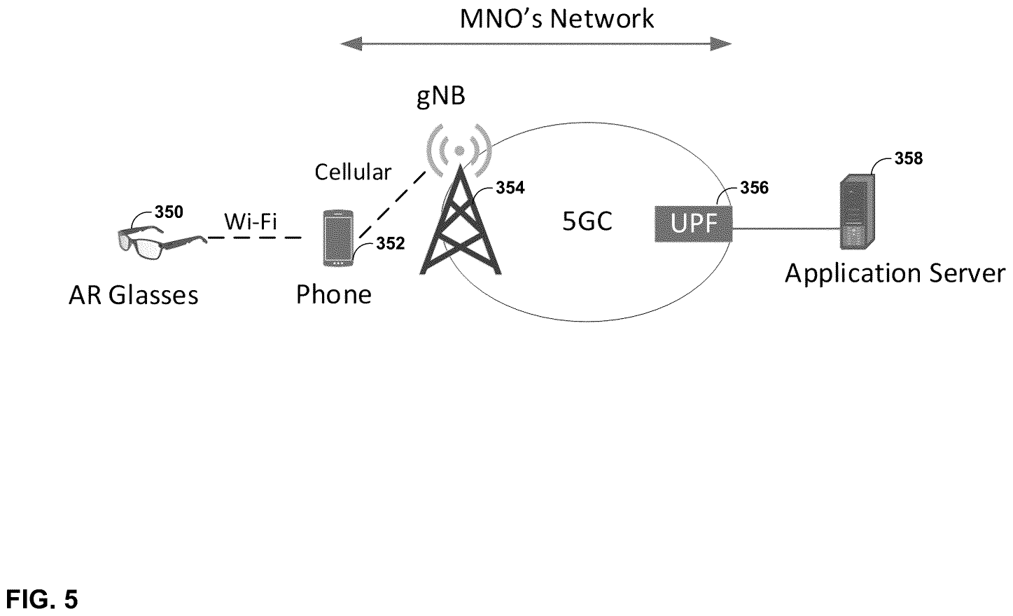

FIG. 5 is a conceptual diagram illustrating an example set of components that may be involved in a WebRTC session for which a UE is tethered to another device. The example of FIG. 3 includes cell phone 352, augmented reality (AR) glasses 350, gNodeB 354, user plane function (UPF) 356, and application server 358. In some examples, a UE device per techniques of this disclosure may be a cellular phone, such as cell phone 352, and a tethered device may be AR glasses, such as AR glasses 350, as in the example of FIG. 5. This disclosure describes various examples indicating devices that may perform WebRTC media functions and control functions, as well as the signaling used to make the resulting architecture work.

In general, cell phone 352 may be configured to communicate with a radio access network, such as the 5G core network (5GC) shown in FIG. 5. AR glasses 350 may be configured to act as a WebRTC endpoint and participate in a WebRTC communication session with another UE device (not shown in FIG. 5), but RAN-specific communication functionality may be performed by cell phone 352. Thus, cell phone 352 may be configured to perform the functionality typically attributed to a media session handler (MSH), for example.

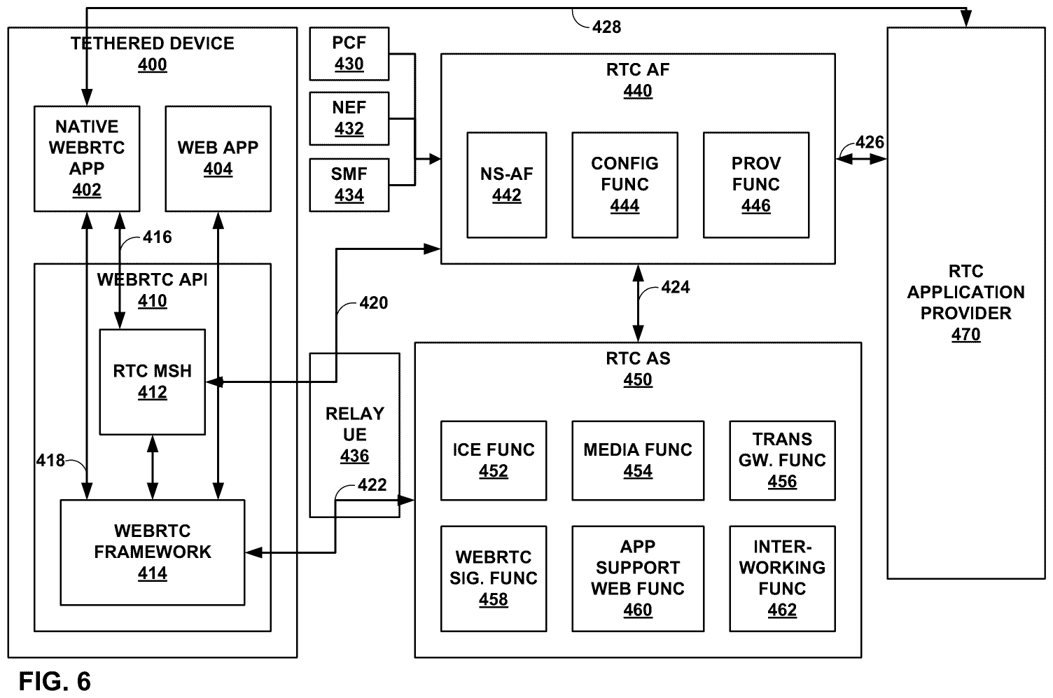

FIGS. 6-8 and 10-12 are block diagrams illustrating example architectures in which the techniques of this disclosure may be performed. In general, WebRTC functions include a WebRTC application (which controls launch of the application, codecs for media data, bitrate control, congestion control, and the like) and the WebRTC support function (which provides access to RTC support functions, including Interactive Connectivity Establishment (ICE) negotiation to establish the connection, quality of experience (QoE) metrics collection, media configuration recommendation to the application, and the like).

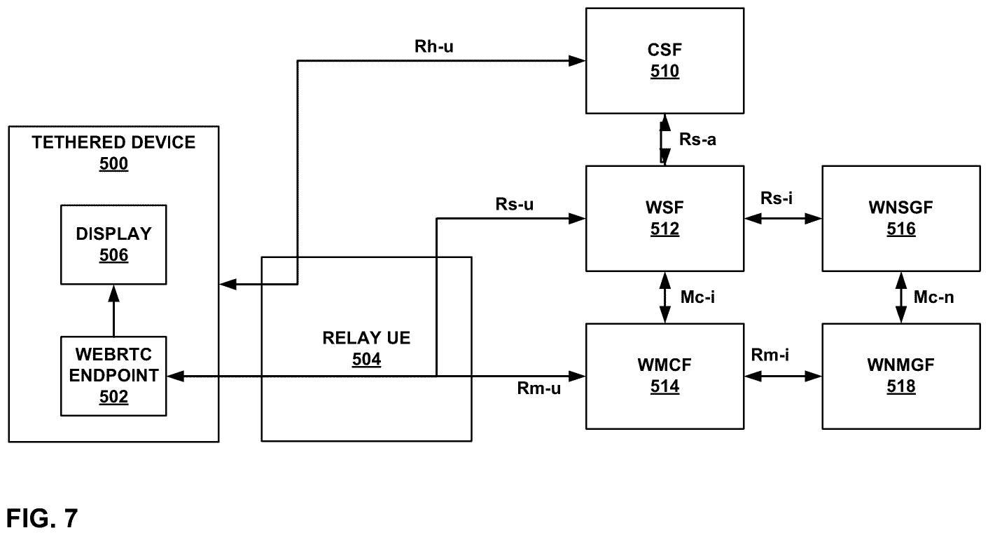

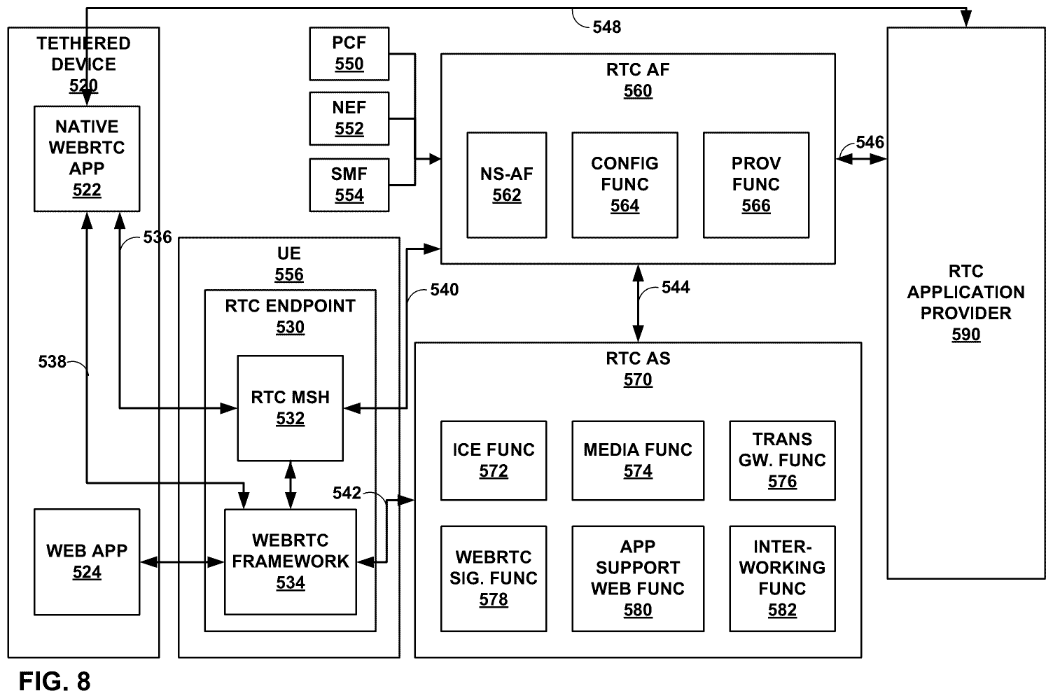

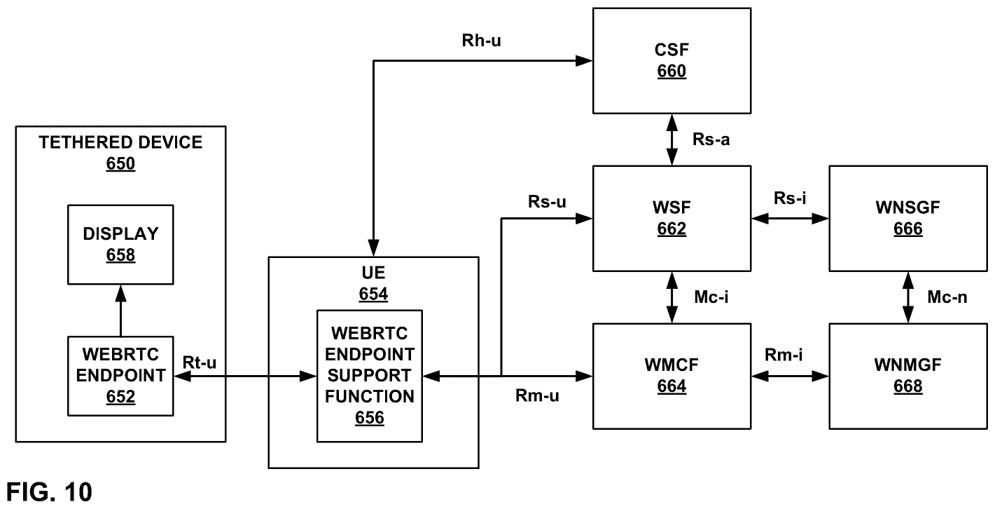

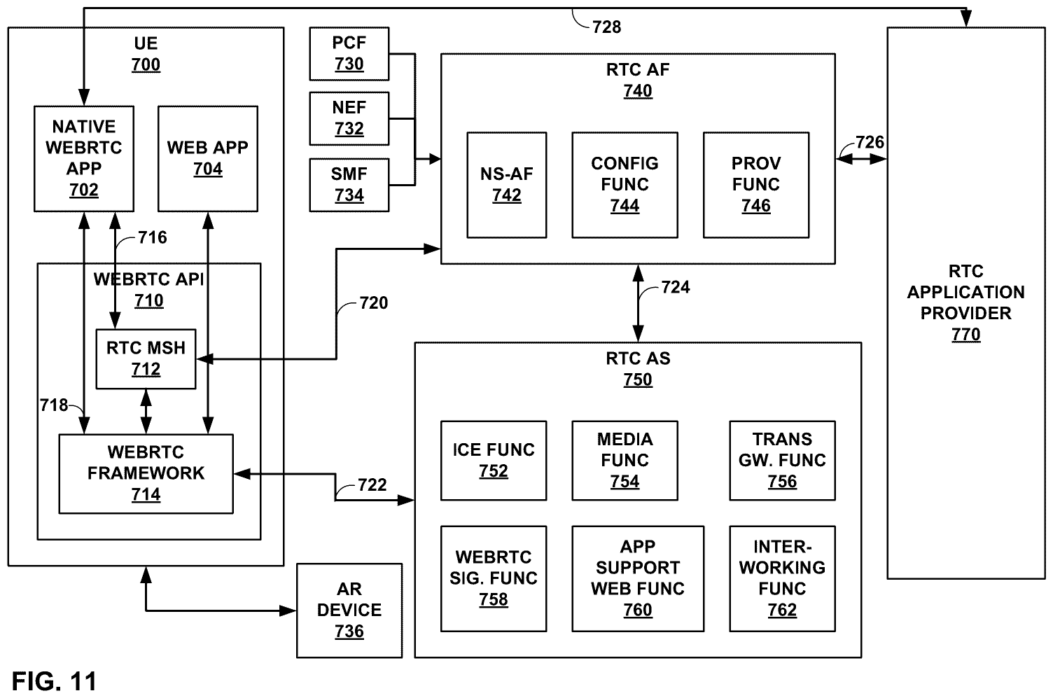

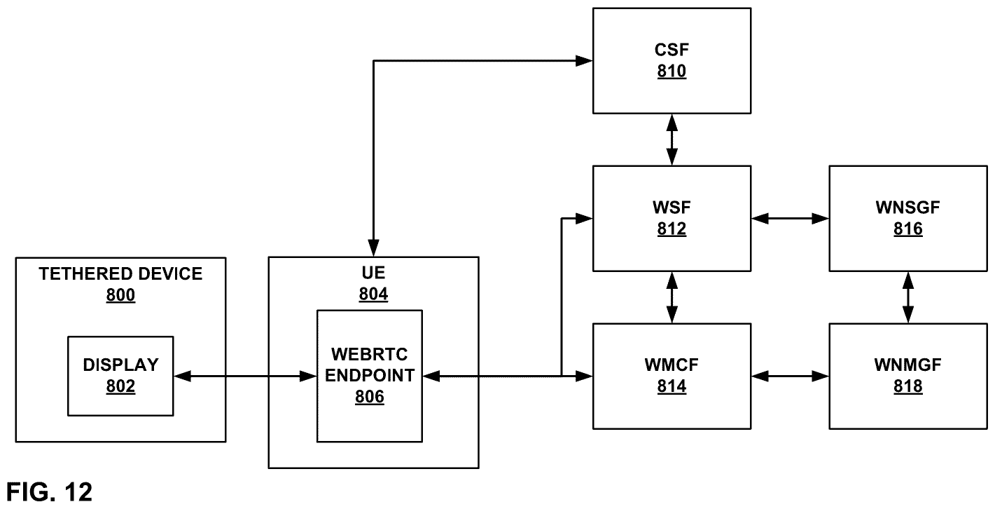

The WebRTC application and WebRTC support function may be split in a variety of ways. In one example, the WebRTC application and the support function are both located on the tethered device (e.g., AR glasses), as shown in the examples of FIGS. 6 and 7. In another example, the WebRTC application is located on the tethered device (e.g., AR glasses) while the support function is located on the tethering device (e.g., the phone or UE), e.g., as shown in FIGS. 8 and 10, in which case the tethering device may act as a relay device. In still another example, the WebRTC application and the support function are both located on the tethering device, and the tethered device serves only as a display, e.g., as shown in FIGS. 11 and 12.

The WebRTC application may be mapped to native WebRTC applications or web applications in the iRTCW architecture, or to the WebRTC Endpoint application in the eiRTCW architecture. The WebRTC support function may be mapped to the RTC Endpoint in the iRTCW architecture, and to the WebRTC Endpoint support function in the eiRTCW architecture.

In particular, the example of FIG. 6 includes tethered device 400, relay UE device 436, RTC application functions (AF) 440, RTC application server (AS) 450, RTC application provider 470, PCF 430, NEF 432, and SMF 434. Tethered device 400 includes native WebRTC application 402, web application 404, WebRTC API 410 including RTC MSH 412 and WebRTC framework 414. Native WebRTC application 402 and RTC MSH 412 are coupled via RTC-6 interface 416. Native WebRTC application 402 and WebRTC framework 414 are coupled via RTC-7 interface 418. Native WebRTC application 402 and RTC application provider 470 are coupled via RTC-8 interface 428.

RTC AF 440 includes NS-AF 442, configuration function 444, and provisioning function 446. RCT MSH 412 and RTC AF 440 are coupled via RTC-5 interface 420, which passes through relay UE 436. RTC AS 450 includes ICE function 452, media function 454, transport gateway function 456, WebRTC signaling functions 458, application support web function 460, and inter-working function 462. WebRTC framework 414 and RTC AS 450 are coupled via RTC-4 interface 422, which passes through relay UE 436. RTC AF 440 and RTC AS 450 are coupled by RTC-3 interface 424. RTC AF 440 and RTC application provider 470 are coupled by RTC-1 interface 426.

FIG. 7 depicts an example in which tethered device 400 includes WebRTC endpoint 502 and a display 506. Tethered device 500 participates in a WebRTC communication session via relay UE 504, which communicates with conference supporting function (CSF) 510, WebRTC signaling function (WSF) 512, and WebRTC media center function (WMCF) 514. WSF 512 communicates with WebRTC NNI signaling gateway function (WNSGF) 516, and WMCF 514 communicates with WebRTC NNI media gateway function (WNMGF) 518. Tethered device 500 may correspond to tethered device 400 of FIG. 6, while relay UE 504 may correspond to relay UE 436 of FIG. 6.

In the examples of FIGS. 6 and 7, the WebRTC endpoint resides on tethered device 400 or tethered device 500, respectively. Relay UE 436 serves as a relay in these examples. In this manner, tethered device 400 of FIG. 6 and tethered device 500 of FIG. 7 represent examples of a tethered device that executes a Web Real-time Communication Protocol (WebRTC) Endpoint Application, wherein the tethered device is tethered to a tethering UE device that executes a WebRTC Endpoint Support Function, and where the tethered device receives media data of a WebRTC session from the tethering UE device.

Likewise, relay UE 436 of FIG. 6 and relay UE 504 represent examples of a tethering UE device that executes a Web Real-time Communication Protocol (WebRTC) Endpoint Support Function, wherein the tethering UE device is tethered to a tethered device that executes a WebRTC Endpoint Application, and where the tethering UE device sends media data of a WebRTC session to the tethered UE device.

The example of FIG. 8 includes tethered device 520, UE device 556, RTC application functions (AF) 560, RTC application server (AS) 570, RTC application provider 590, PCF 550, NEF 552, and SMF 554. Tethered device 520 includes native WebRTC application 522 and web application 524. UE device 556 includes RTC endpoint 530 including RTC MSH 532 and WebRTC framework 534. Native WebRTC application 522 and RTC MSH 532 are coupled via RTC-6′ interface 536. Native WebRTC application 522 and WebRTC framework 534 are coupled via RTC-7′ interface 538. Native WebRTC application 522 and RTC application provider 590 are coupled via RTC-8 interface 548. Web application 524 and WebRTC framework 534 are coupled via a WebRTC API.

RTC AF 560 includes NS-AF 562, configuration function 564, and provisioning function 566. RCT MSH 532 and RTC AF 560 are coupled via RTC-5 interface 420. RTC AS 570 includes ICE function 572, media function 574, transport gateway function 576, WebRTC signaling functions 578, application support web function 580, and inter-working function 582. WebRTC framework 534 and RTC AS 450 are coupled via RTC-4 interface 542. RTC AF 560 and RTC AS 570 are coupled by RTC-3 interface 544. RTC AF 560 and RTC application provider 590 are coupled by RTC-1 interface 546.

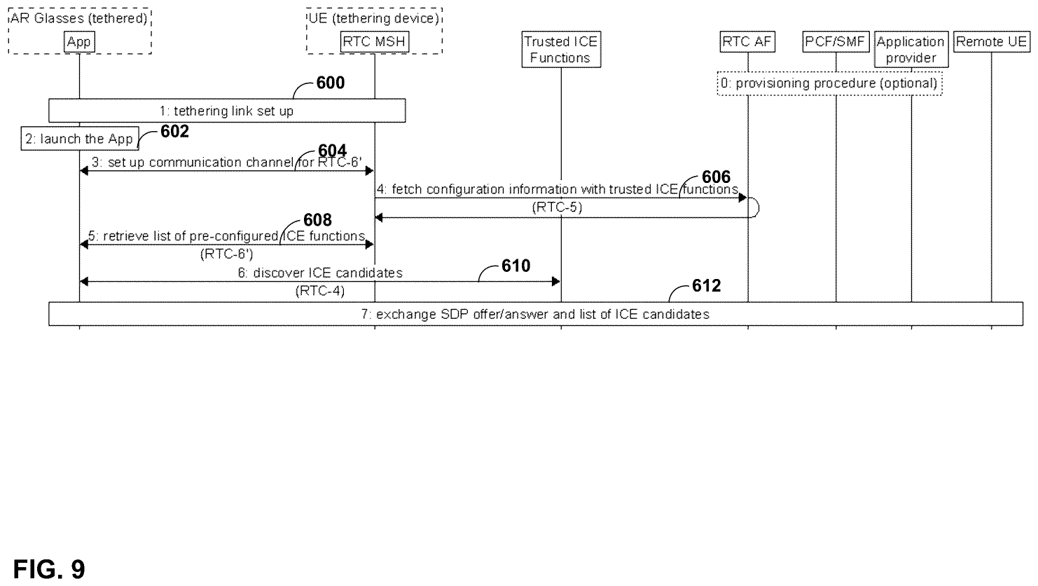

FIG. 9 is a flow diagram illustrating an example WebRTC setup procedure for the iRTCW architecture according to techniques of this disclosure. A provisioning session may first have been created by the application provider (AP) with the mobile network operator (MNO). This may provision information about STUN/TURN servers used in ICE procedures. Then, the tethered device and the tethering device may establish a tethering link (600). The tethering link may be a 3GPP link (e.g., sidelink on PC5) or a non-3GPP link (e.g., Wi-Fi). The setup may involve authentication.

The tethered device may then launch the WebRTC App (e.g., a browser app, or a non-browser WebRTC App) (602).

The tethered device and the tethering device may then establish a communication channel for RTC-6′ between the WebRTC App and the RTC MSH (604). RTC-6′ may be different from RTC-6 in that RTC-6′ is between two different devices, whereas RTC-6 is within the same device, as shown in FIG. 8 with RTC-6′ interface 536. The setup may involve choosing a protocol (e.g., TCP, UDP, or the like) and port numbers (e.g., the port number for the WebRTC App and the port number for the RTC MSH) to be used. Additionally or alternatively, control channel RTC-7′ and/or a WebRTC API may be set up similarly.

The RTC MSH may then fetch configuration parameters from trusted ICE functions (606). For example, the RTC MSH may receive a list of trusted STUN/TURN servers that the UE may use to establish RTC sessions.

The WebRTC App may then retrieve the list of trusted ICE servers from the RTC MSH (608) via RTC-6′.

The UE may discover and test the ICE candidates to find the candidates that are suitable for the connection (610).

The WebRTC App on the tethered device and the remote RTC endpoint may then establish the WebRTC communication session (e.g., via SDP) (612).

The example of FIG. 10 includes tethered device 650, including WebRTC endpoint application 652 and display 658, and UE device 654, including WebRTC endpoint support function 656. Tethered device 650 participates in a WebRTC communication session via UE device 654, which communicates with conference supporting function (CSF) 660, WebRTC signaling function (WSF) 662, and WebRTC media center function (WMCF) 664. WSF 662 communicates with WebRTC NNI signaling gateway function (WNSGF) 666, and WMCF 664 communicates with WebRTC NNI media gateway function (WNMGF) 668. Tethered device 650 may correspond to tethered device 520 of FIG. 8, while UE device 654 may correspond to UE device 556 of FIG. 8.

In the example of FIG. 10, RT-u represents an interface between WebRTC Endpoint application 652 and WebRTC Endpoint Support function 656. Rt-u may be mapped to the RTC-6′ interface 536, WebRTC API 2 interface, and RTC-7′ interface 538 in the iRTCW architecture shown in FIG. 8.

When WebRTC Endpoint application 652 is started, WebRTC Endpoint application 652 may communicate with WebRTC Endpoint Support Function 656 on UE 654 through the Rt-u interface. The communication may trigger further communication between UE 654 and WebRTC support functions in the cellular system over the Rh-u, Rs-u, and Rm-u interfaces.

The Rt-u interface is not within the same device as UE 654, and thus, may require setup of a communication channel, which may be defined by a protocol (e.g., TCP, UDP, SCTP, etc.) and a pair of port numbers (one for the tethered device and another for the tethering device).

In this manner, UE 556 of FIG. 8 and UE 654 of FIG. 10 represent examples of a tethering UE device for participating in a Web Real-time Communication Protocol (WebRTC) communication session, including: a memory configured to store media data; a communication interface communicatively coupled to a tethered device that executes a WebRTC Endpoint Application; and a processing system implemented in circuitry and configured to: execute a WebRTC Endpoint Support Function to access WebRTC signaling functions of a WebRTC operator network and to receive media data of a WebRTC communication session from the WebRTC operator network; and send the received media data of the WebRTC communication session to the tethered device to cause the tethered device to present the media data.

Likewise, tethered device 520 of FIG. 8 and tethered device 650 of FIG. 10 represent examples of a tethered device for exchanging media data, including: a memory configured to store media data; at least one display; a communication interface communicatively coupled to a tethering user equipment (UE) device that executes a Web Real-time Communication Protocol (WebRTC) Endpoint Support Function; and a processing system implemented in circuitry and configured to: execute a WebRTC Endpoint Application to participate in a WebRTC communication session; receive media data of the WebRTC communication session from the tethering UE device; and present the media data of the WebRTC communication session via the at least one display.

The example of FIG. 11 includes UE device 700, AR device 736, RTC application functions (AF) 740, RTC application server (AS) 750, RTC application provider 770, PCF 730, NEF 732, and SMF 734. UE device 700 includes native WebRTC application 702, web application 704, and WebRTC API 710 including RTC MSH 712 and WebRTC framework 714. Native WebRTC application 702 and RTC MSH 712 are coupled via RTC-6 interface 716. Native WebRTC application 702 and WebRTC framework 714 are coupled via RTC-7 interface 718. Native WebRTC application 702 and RTC application provider 770 are coupled via RTC-8 interface 728.

RTC AF 740 includes NS-AF 742, configuration function 744, and provisioning function 746. RCT MSH 712 and RTC AF 740 are coupled via RTC-5 interface 720. RTC AS 750 includes ICE function 752, media function 754, transport gateway function 756, WebRTC signaling functions 758, application support web function 760, and inter-working function 762. WebRTC framework 714 and RTC AS 750 are coupled via RTC-4 interface 722. RTC AF 740 and RTC AS 750 are coupled by RTC-3 interface 724. RTC AF 740 and RTC application provider 770 are coupled by RTC-1 interface 726. In this example, UE device 700 provides media data of a WebRTC

communication session (e.g., an AR communication session that includes audio, video, image, and/or AR data, such as MR, XR, and/or VR data) to AR device 736. UE device 700 otherwise performs the majority of the WebRTC communication session functions with RTC AF 740, RTC AS 750, and RTC application provider 770.

The example of FIG. 12 includes tethered device 800, including display 802, and UE device 804 including WebRTC endpoint 806. WebRTC endpoint 806 communicates with conference supporting function (CSF) 810, WebRTC signaling function (WSF) 812, and WebRTC media center function (WMCF) 814. WSF 812 communicates with WebRTC NNI signaling gateway function (WNSGF) 816, and WMCF 814 communicates with WebRTC NNI media gateway function (WNMGF) 818. Tethered device 800 may correspond to AR device 736 of FIG. 11, while UE device 804 may correspond to UE device 700 of FIG. 11.

In this manner, UE device 700 of FIG. 11 and UE device 804 of FIG. 12 represent examples of a tethering UE device that executes a Web Real-time Communication Protocol (WebRTC) Endpoint Support Function and a WebRTC Endpoint Application to receive media data of a WebRTC communication session and to send the media data to a tethered device for output to a user.

Likewise, AR device 736 of FIG. 11 and tethered device 800 of FIG. 12 represent examples of a tethered device that receives media data of a Web Real-time Communication Protocol (WebRTC) communication session from a tethering UE device that executes a WebRTC Endpoint Support Function and a WebRTC Endpoint Application.

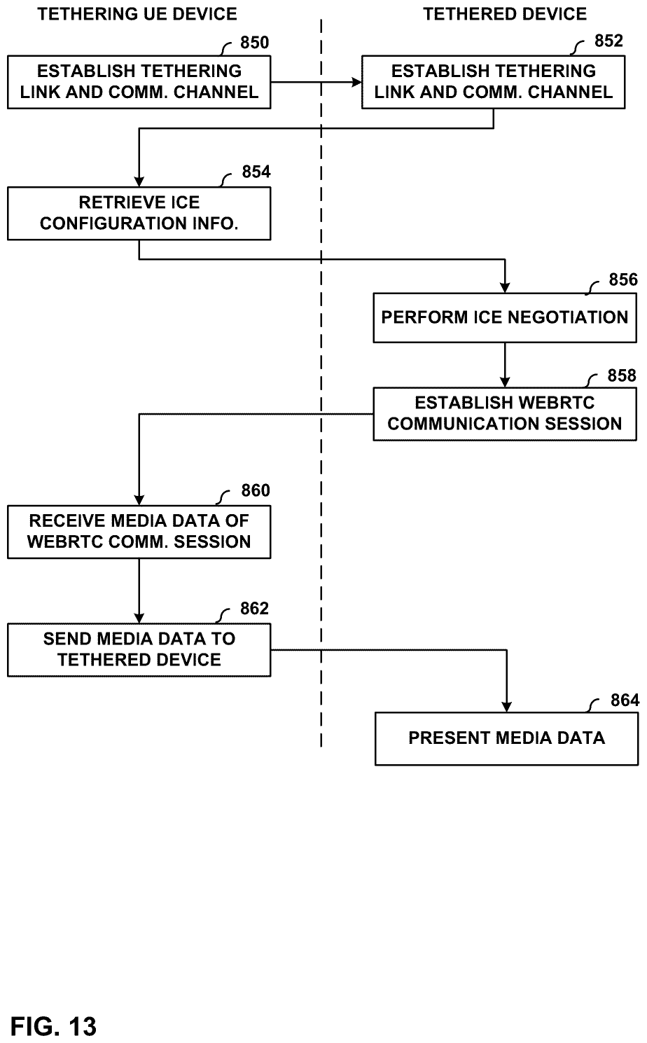

FIG. 13 is a flowchart illustrating an example method that may be performed by a tethering user equipment (UE) device, such as a cell phone, and a tethered device, such as augmented reality (AR) glasses. The tethering UE device may generally execute a WebRTC Endpoint Support Function, and the tethered device may generally execute a WebRTC Endpoint Application. For example, the tethering UE device may correspond to UE 556 of FIG. 8 or UE 654 of FIG. 10, while the tethered device may correspond to tethered device 520 of FIG. 8 or tethered device 650 of FIG. 10.

Initially, the tethering UE device and the tethered device may establish a tethering link and a communication channel between each other (850, 852). The tethering UE device may then retrieve Interactive Connectivity Establishment (ICE) configuration information from one or more ICE servers (854). The tethering UE device may provide the ICE configuration information to the tethered device.

The tethered device may then use the ICE configuration information to perform ICE negotiation (856). For example, the tethered device may retrieve a list of pre-configured ICE functions and discover ICE candidates. The tethered device may then exchange a session description protocol (SDP) offer or answer and a list of ICE candidates with a remote UE to establish a WebRTC communication session with the remote UE (858).

The tethering UE device may then receive media data of the WebRTC communication session (860) and send the media data to the tethered device (862). The tethered device may then present the media data (864), e.g., via displays, speakers, or the like.

In this manner, the method of FIG. 13 represents an example of a method of exchanging media data, including: executing, by a tethering user equipment (UE) device, a Web Real-time Communication Protocol (WebRTC) Endpoint Support Function to access WebRTC signaling functions of a WebRTC operator network and to receive media data of a WebRTC communication session from the WebRTC operator network, wherein the tethering UE device is tethered to a tethered device that executes a WebRTC Endpoint Application; and sending, by the tethering UE device, the received media data of the WebRTC communication session to the tethered device to cause the tethered device to present the media data.

The method of FIG. 13 also represents an example of a method of exchanging media data, including: executing, by a tethered device, a Web Real-time Communication Protocol (WebRTC) Endpoint Application to participate in a WebRTC communication session, wherein the tethered device is tethered to a tethering UE device that executes a WebRTC Endpoint Support Function; receiving, by the tethered device, media data of the WebRTC communication session from the tethering UE device; and presenting, by the tethered device, the media data of the WebRTC communication session.

The clauses below represent various examples of the techniques of this disclosure:

Clause 1: A method of exchanging media data, the method comprising: executing, by a user equipment (UE) device, a Web Real-time Communication Protocol (WebRTC) Endpoint Support Function, wherein the UE device is tethered to a tethered UE device that executes a WebRTC Endpoint Application; and sending, by the UE device, media data of a WebRTC session to the tethered UE device.

Clause 2: A method of exchanging media data, the method comprising: executing, by a tethered user equipment (UE) device, a Web Real-time Communication Protocol (WebRTC) Endpoint Application, wherein the tethered UE device is tethered to a tethering UE device that executes a WebRTC Endpoint Support Function; and receiving, by the tethered UE device, media data of a WebRTC session from the tethering UE device.

Clause 3: A method of exchanging media data, the method comprising: executing, by a user equipment (UE) device, a Web Real-time Communication Protocol (WebRTC) Endpoint Support Function and a WebRTC Endpoint Application, wherein the UE device is tethered to a tethered UE device; and sending, by the UE device, media data of a WebRTC session to the tethered UE device.

Clause 4: A method of exchanging media data, the method comprising: receiving, by a tethered user equipment (UE) device, from a tethering UE device that executes a Web Real-time Communication Protocol (WebRTC) Endpoint Support Function and a WebRTC Endpoint Application, media data of a WebRTC session.

Clause 5: A method of exchanging media data, the method comprising: sending, by a user equipment (UE) device, to a tethered UE device that executes a Web Real-time Communication Protocol (WebRTC) Endpoint Support Function and a WebRTC Endpoint Application, media data of a WebRTC session.

Clause 6: A method of exchanging media data, the method comprising: executing, by a tethered user equipment (UE) device, a Web Real-time Communication Protocol (WebRTC) Endpoint Support Function and a WebRTC Endpoint Application, wherein the UE device is tethered to a tethering UE device; and receiving, from the tethering UE device, media data of a WebRTC session.

Clause 7: The method of any of clauses 1-6, wherein the UE device comprises a cellular phone.

Clause 8: The method of any of clauses 1-7, wherein the tethered UE device comprises augmented reality (AR) glasses.

Clause 9: The method of any of clauses 1-8, wherein the method further includes: establishing a tethering link between the UE device and the tethered UE device; launching the WebRTC Endpoint Application; establishing an RTC-6′ communication channel between the UE device and the tethered UE device; retrieving configuration information from one or more Interactive Connectivity Establishment (ICE) servers; retrieving a list of pre-configured ICE functions; discovering ICE candidates from the list of pre-configured ICE functions; and establishing a communication session with a remote UE using the ICE candidates.

Clause 10: The method of clause 9, wherein establishing the communication session comprises establishing the communication session using Session Description Protocol (SDP).

Clause 11: The method of any of clauses 1-10, wherein the UE device and the tethered UE device are configured to communicate via a Rt-u interface.

Clause 12: A device for exchanging media data, the device comprising one or more means for performing the method of any of clauses 1-11.

Clause 13: The device of clause 12, wherein the one or more means comprise a processing system comprising one or more processors implemented in circuitry.

Clause 14: The device of clause 12, wherein the apparatus comprises at least one of: an integrated circuit; a microprocessor; and a wireless communication device.

Clause 15: A computer-readable storage medium having stored thereon instructions that, when executed, cause a processing system to perform the method of any of clauses 1-11.

Clause 16: A user equipment (UE) device for exchanging media data, the UE device comprising: means for executing a Web Real-time Communication Protocol (WebRTC) Endpoint Support Function, wherein the UE device is tethered to a tethered UE device that executes a WebRTC Endpoint Application; and means for sending media data of a WebRTC session to the tethered UE device.

Clause 17: A tethered user equipment (UE) device for exchanging media data, the tethered UE device comprising: means for executing a Web Real-time Communication Protocol (WebRTC) Endpoint Application, wherein the tethered UE device is tethered to a tethering UE device that executes a WebRTC Endpoint Support Function; and means for receiving media data of a WebRTC session from the tethering UE device.

Clause 18: A method of exchanging media data, the method comprising: executing, by a tethering user equipment (UE) device, a Web Real-time Communication Protocol (WebRTC) Endpoint Support Function to access WebRTC signaling functions of a WebRTC operator network and to receive media data of a WebRTC communication session from the WebRTC operator network, wherein the tethering UE device is tethered to a tethered device that executes a WebRTC Endpoint Application; and sending, by the tethering UE device, the received media data of the WebRTC communication session to the tethered device to cause the tethered device to present the media data.

Clause 19: The method of clause 18, wherein the tethering UE device comprises a cellular phone and the tethered device comprises augmented reality (AR) glasses.

Clause 20: The method of clause 18, further comprising: establishing, by the tethering UE device, a tethering link with the tethered device; establishing, by the tethering UE device, a communication channel with the tethered device; retrieving, by the tethering UE device, configuration information from one or more Interactive Connectivity Establishment (ICE) servers; retrieving, by the tethering UE device, a list of pre-configured ICE functions; discovering, by the tethering UE device, ICE candidates from the list of pre-configured ICE functions; and establishing, by the tethering UE device, the WebRTC communication session with a remote UE using the ICE candidates.

Clause 21: The method of clause 20, wherein establishing the WebRTC communication session comprises establishing the WebRTC communication session using Session Description Protocol (SDP).

Clause 22: The method of clause 18, further comprising establishing, by the tethering UE device, a communication channel with the tethered device via an Rt-u interface.

Clause 23: The method of clause 18, further comprising establishing, by the tethering UE device, a Wi-Fi communication connection with the tethered device.

Clause 24: The method of clause 18, wherein executing the WebRTC Endpoint Support Function comprises executing the WebRTC Endpoint Support Function to collect quality of experience (QoE) metrics and providing a media configuration recommendation to the WebRTC Endpoint Application of the tethered device.

Clause 25: A tethering user equipment (UE) device for participating in a Web Real-time Communication Protocol (WebRTC) communication session, the tethering UE device comprising: a memory configured to store media data; a communication interface communicatively coupled to a tethered device that executes a WebRTC Endpoint Application; and a processing system implemented in circuitry and configured to: execute a WebRTC Endpoint Support Function to access WebRTC signaling functions of a WebRTC operator network and to receive media data of a WebRTC communication session from the WebRTC operator network; and send the received media data of the WebRTC communication session to the tethered device to cause the tethered device to present the media data.

Clause 26: The tethering UE device of clause 25, wherein the tethering UE device comprises a cellular phone and the tethered device comprises augmented reality (AR) glasses.

Clause 27: The tethering UE device of clause 25, wherein the processing system is further configured to: establish a tethering link with the tethered device; establish a communication channel with the tethered device; retrieve configuration information from one or more Interactive Connectivity Establishment (ICE) servers; retrieve a list of pre-configured ICE functions; discover ICE candidates from the list of pre-configured ICE functions; and establish the WebRTC communication session with a remote UE using the ICE candidates.

Clause 28: The tethering UE device of clause 27, wherein the processing system is configured to establish the WebRTC communication session using Session Description Protocol (SDP).

Clause 29: The tethering UE device of clause 25, wherein the processing system is further configured to establish a communication channel with the tethered device via an Rt-u interface.

Clause 30: The tethering UE device of clause 25, wherein the processing system is further configured to establish a Wi-Fi communication connection with the tethered device.

Clause 31: The tethering UE device of clause 25, wherein the WebRTC Endpoint Support Function is configured to collect quality of experience (QoE) metrics and to provide a media configuration recommendation to the WebRTC Endpoint Application of the tethered device.

Clause 32: A method of exchanging media data, the method comprising: executing, by a tethered device, a Web Real-time Communication Protocol (WebRTC) Endpoint Application to participate in a WebRTC communication session, wherein the tethered device is tethered to a tethering UE device that executes a WebRTC Endpoint Support Function; receiving, by the tethered device, media data of the WebRTC communication session from the tethering UE device; and presenting, by the tethered device, the media data of the WebRTC communication session.

Clause 33: The method of clause 32, wherein the tethering UE device comprises a cellular phone and the tethered device comprises augmented reality (AR) glasses.

Clause 34: The method of clause 32, further comprising: establishing, by the tethered device, a tethering link with the tethering UE device; establishing, by the tethered device, a communication channel with the tethering UE device; and executing, by the tethered device, the WebRTC Endpoint Application to participate in the WebRTC communication session.

Clause 35: The method of clause 34, wherein executing the WebRTC Endpoint Application to participate in the WebRTC communication session comprises executing the WebRTC Endpoint Application to collect user movement data and to send the user movement data to the tethering UE device to cause the tethering UE device to send the user movement data as part of the WebRTC communication session.

Clause 36: The method of clause 32, further comprising establishing, by the tethered device, a communication session with the tethering UE device via an Rt-u interface.

Clause 37: The method of clause 32, further comprising establishing, by the tethered device, a Wi-Fi communication connection with the tethering UE device.

Clause 38: The method of clause 32, wherein executing the WebRTC Endpoint Application comprises executing the WebRTC Endpoint Application to encode and decode media data of the WebRTC communication session, perform bitrate control, and perform network congestion control.

Clause 39: A tethered device for exchanging media data, the tethered device comprising: a memory configured to store media data; at least one display; a communication interface communicatively coupled to a tethering user equipment (UE) device that executes a Web Real-time Communication Protocol (WebRTC) Endpoint Support Function; and a processing system implemented in circuitry and configured to: execute a WebRTC Endpoint Application to participate in a WebRTC communication session; receive media data of the WebRTC communication session from the tethering UE device; and present the media data of the WebRTC communication session via the at least one display.

Clause 40: The device of clause 39, wherein the tethering UE device comprises a cellular phone and the tethered device comprises augmented reality (AR) glasses.

Clause 41: The device of clause 39, wherein the processing system is further configured to: establish a tethering link with the tethering UE device; establish a communication channel with the tethering UE device; and execute the WebRTC Endpoint Application to participate in the WebRTC communication session.

Clause 42: The device of clause 41, further comprising one or more movement detection sensors, wherein to execute the WebRTC Endpoint Application to participate in the WebRTC communication session, the processing system is configured to collect user movement data via the movement detection sensors and to send the user movement data to the tethering UE device to cause the tethering UE device to send the user movement data as part of the WebRTC communication session.

Clause 43: The device of clause 39, wherein the processing system is further configured to establish a communication session with the tethering UE device via an Rt-u interface.

Clause 44: The device of clause 39, wherein the processing system is further configured to establish a Wi-Fi communication connection with the tethering UE device.

Clause 45: The device of clause 39, wherein the WebRTC Endpoint Application is configured to encode and decode media data of the WebRTC communication session, perform bitrate control, and perform network congestion control.

Clause 46: A system for exchanging media data of a Web Real-time Communication Protocol (WebRTC) communication session, the system comprising: a tethered device for participating in the WebRTC communication session; and a tethering user equipment (UE) device for participating in the WebRTC communication session, the tethering UE device comprising: a memory configured to store media data; a communication interface communicatively coupled to the tethered device; and a processing system implemented in circuitry and configured to: execute a WebRTC Endpoint Support Function to access WebRTC signaling functions of a WebRTC operator network and to receive media data of the WebRTC communication session from the WebRTC operator network; and send the received media data of the WebRTC communication session to the tethered device to cause the tethered device to present the media data, wherein the tethered device comprises: a memory configured to store media data; at least one display; a communication interface communicatively coupled to the tethering user UE; and a processing system implemented in circuitry and configured to: execute a WebRTC Endpoint Application to participate in the WebRTC communication session; receive media data of the WebRTC communication session from the tethering UE device; and present the media data of the WebRTC communication session via the at least one display.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of exchanging media data, the method comprising:
executing, by a tethering user equipment (UE) device, a Web Real-time Communication Protocol (WebRTC) Endpoint Support Function to access WebRTC signaling functions of a WebRTC operator network and to receive media data of a WebRTC communication session from the WebRTC operator network, wherein the tethering UE device is tethered to a tethered device that executes a WebRTC Endpoint Application; and
sending, by the tethering UE device, the received media data of the WebRTC communication session to the tethered device to cause the tethered device to present the media data.

2. The method of claim 1, wherein the tethering UE device comprises a cellular phone and the tethered device comprises augmented reality (AR) glasses.

3. The method of claim 1, further comprising:
establishing, by the tethering UE device, a tethering link with the tethered device;
establishing, by the tethering UE device, a communication channel with the tethered device;
retrieving, by the tethering UE device, configuration information from one or more Interactive Connectivity Establishment (ICE) servers; and
sending, by the tethering UE device, the configuration information to the tethered device.

4. The method of claim 3, wherein establishing the WebRTC communication session comprises establishing the WebRTC communication session using Session Description Protocol (SDP).

5. The method of claim 1, further comprising establishing, by the tethering UE device, a communication channel with the tethered device via an Rt-u interface.

6. The method of claim 1, further comprising establishing, by the tethering UE device, a Wi-Fi communication connection with the tethered device.

7. The method of claim 1, wherein executing the WebRTC Endpoint Support Function comprises executing the WebRTC Endpoint Support Function to collect quality of experience (QoE) metrics and providing a media configuration recommendation to the WebRTC Endpoint Application of the tethered device.

8. A tethering user equipment (UE) device for participating in a Web Real-time Communication Protocol (WebRTC) communication session, the tethering UE device comprising:
a memory configured to store media data;
a communication interface communicatively coupled to a tethered device that executes a WebRTC Endpoint Application; and
a processing system implemented in circuitry and configured to:
execute a WebRTC Endpoint Support Function to access WebRTC signaling functions of a WebRTC operator network and to receive media data of a WebRTC communication session from the WebRTC operator network; and
send the received media data of the WebRTC communication session to the tethered device to cause the tethered device to present the media data.

9. The tethering UE device of claim 8, wherein the tethering UE device comprises a cellular phone and the tethered device comprises augmented reality (AR) glasses.

10. The tethering UE device of claim 8, wherein the processing system is further configured to:
establish a tethering link with the tethered device;
establish a communication channel with the tethered device;
retrieve configuration information from one or more Interactive Connectivity Establishment (ICE) servers; and
send the configuration information to the tethered device.

11. The tethering UE device of claim 10, wherein the processing system is configured to establish the WebRTC communication session using Session Description Protocol (SDP).

12. The tethering UE device of claim 8, wherein the processing system is further configured to establish a communication channel with the tethered device via an Rt-u interface.

13. The tethering UE device of claim 8, wherein the processing system is further configured to establish a Wi-Fi communication connection with the tethered device.

14. The tethering UE device of claim 8, wherein the WebRTC Endpoint Support Function is configured to collect quality of experience (QoE) metrics and to provide a media configuration recommendation to the WebRTC Endpoint Application of the tethered device.

15. A method of exchanging media data, the method comprising:
executing, by a tethered device, a Web Real-time Communication Protocol (WebRTC) Endpoint Application to participate in a WebRTC communication session, wherein the tethered device is tethered to a tethering UE device that executes a WebRTC Endpoint Support Function;
receiving, by the tethered device, media data of the WebRTC communication session from the tethering UE device; and
presenting, by the tethered device, the media data of the WebRTC communication session.

16. The method of claim 15, wherein the tethering UE device comprises a cellular phone and the tethered device comprises augmented reality (AR) glasses.

17. The method of claim 15, further comprising:
establishing, by the tethered device, a tethering link with the tethering UE device;
establishing, by the tethered device, a communication channel with the tethering UE device;
receiving, by the tethered device, a list of pre-configured ICE functions;
discovering, by the tethered device, ICE candidates from the list of pre-configured ICE functions;
establishing, by the tethered device, the WebRTC communication session with a remote UE using the ICE candidates; and
executing, by the tethered device, the WebRTC Endpoint Application to participate in the WebRTC communication session.

18. The method of claim 17, wherein executing the WebRTC Endpoint Application to participate in the WebRTC communication session comprises executing the WebRTC Endpoint Application to collect user movement data and to send the user movement data to the tethering UE device to cause the tethering UE device to send the user movement data as part of the WebRTC communication session.

19. The method of claim 15, further comprising establishing, by the tethered device, a communication session with the tethering UE device via an Rt-u interface.

20. The method of claim 15, further comprising establishing, by the tethered device, a Wi-Fi communication connection with the tethering UE device.

21. The method of claim 15, wherein executing the WebRTC Endpoint Application comprises executing the WebRTC Endpoint Application to encode and decode media data of the WebRTC communication session, perform bitrate control, and perform network congestion control.

22. A tethered device for exchanging media data, the tethered device comprising:
a memory configured to store media data;
at least one display;
a communication interface communicatively coupled to a tethering user equipment (UE) device that executes a Web Real-time Communication Protocol (WebRTC) Endpoint Support Function; and
a processing system implemented in circuitry and configured to:
execute a WebRTC Endpoint Application to participate in a WebRTC communication session;
receive media data of the WebRTC communication session from the tethering UE device; and
present the media data of the WebRTC communication session via the at least one display.

23. The device of claim 22, wherein the tethering UE device comprises a cellular phone and the tethered device comprises augmented reality (AR) glasses.

24. The device of claim 22, wherein the processing system is further configured to:
establish a tethering link with the tethering UE device;
establish a communication channel with the tethering UE device;
retrieve a list of pre-configured ICE functions;
discover ICE candidates from the list of pre-configured ICE functions;
establish the WebRTC communication session with a remote UE using the ICE candidates; and
execute the WebRTC Endpoint Application to participate in the WebRTC communication session.

25. The device of claim 24, further comprising one or more movement detection sensors, wherein to execute the WebRTC Endpoint Application to participate in the WebRTC communication session, the processing system is configured to collect user movement data via the movement detection sensors and to send the user movement data to the tethering UE device to cause the tethering UE device to send the user movement data as part of the WebRTC communication session.

26. The device of claim 22, wherein the processing system is further configured to establish a communication session with the tethering UE device via an Rt-u interface.

27. The device of claim 22, wherein the processing system is further configured to establish a Wi-Fi communication connection with the tethering UE device.

28. The device of claim 22, wherein the WebRTC Endpoint Application is configured to encode and decode media data of the WebRTC communication session, perform bitrate control, and perform network congestion control.

29. A system for exchanging media data of a Web Real-time Communication Protocol (WebRTC) communication session, the system comprising:
a tethered device for participating in the WebRTC communication session; and
a tethering user equipment (UE) device for participating in the WebRTC communication session, the tethering UE device comprising:
a memory configured to store media data;
a communication interface communicatively coupled to the tethered device; and
a processing system implemented in circuitry and configured to:
execute a WebRTC Endpoint Support Function to access WebRTC signaling functions of a WebRTC operator network and to receive media data of the WebRTC communication session from the WebRTC operator network; and
send the received media data of the WebRTC communication session to the tethered device to cause the tethered device to present the media data,
wherein the tethered device comprises:
a memory configured to store media data;
at least one display;
a communication interface communicatively coupled to the tethering user UE; and
a processing system implemented in circuitry and configured to:
execute a WebRTC Endpoint Application to participate in the WebRTC communication session;
receive media data of the WebRTC communication session from the tethering UE device; and
present the media data of the WebRTC communication session via the at least one display.
